(19) United States
(12) Patent Application Publication
(10) Pub. No.: US 2016/0221558 A1
(43) Pub. Date: Aug. 4, 2016

(54) BRAKE CONTROL APPARATUS

(71) Applicant: HITACHI AUTOMOTIVE SYSTEMS, LTD., Ibaraki (JP)

(72) Inventors: Shinichiro NISHIDA, Zama-shi, Kanagawa (JP); Masamichi IMAMURA, Atsugi-shi, Kanagawa (JP)

(73) Assignee: HITACHI AUTOMOTIVE SYSTEMS, LTD., Hitachinaka-shi, Ibaraki (JP)

(21) Appl. No.: 15/021,142

(22) PCT Filed: Aug. 29, 2014
(86) PCT No.: PCT/JP2014/072774

§ 371 Date: Mar. 10, 2016

(30) Foreign Application Priority Data
Sep. 19, 2013 (JP) 2013-194383

(51) Int. Cl. B60T 13/66; B60T 13/68; B60T 13/14

(52) U.S. Cl. CPC B60T 13/662; B60T 13/146; B60T 13/686

(57) ABSTRACT

The present invention provides a brake control apparatus capable of preventing or reducing excessive opening of a pressure regulating valve, which otherwise might be caused by pump pulsation, without leading to an increase in the size of the apparatus. The brake control apparatus alternately supplies power corresponding to a predetermined current value for acquiring a target wheel cylinder hydraulic pressure and power corresponding to a larger current value than this predetermined current value to a solenoid of a gate-out valve 3.

### TECHNICAL FIELD

The present invention relates to a brake control apparatus.

### BACKGROUND ART

Patent Literature 1 discloses a technique that controls a hydraulic pressure in a wheel cylinder by adjusting a differential pressure at a pressure regulating valve disposed in a circuit connecting a master cylinder and the wheel cylinder to each other when controlling the hydraulic pressure based on driving of a pump.

### CITATION LIST

### Patent Literature

PTL 1: Japanese Patent Application Public Disclosure No. 2011-105207

### SUMMARY OF INVENTION

### Technical Problem

However, the above-described conventional technique involves such a drawback that pump pulsation affects the pressure regulating valve, thereby causing the pressure regulating valve to be excessively opened, resulting in a reduction in the hydraulic pressure in the wheel cylinder. On the other hand, one possible solution therefor is to provide a damper capable of absorbing the pump pulsation on a discharge side of the pump, but this solution leads to an increase in the size of the apparatus.

An object of the present invention is to provide a brake control apparatus capable of preventing or reducing excessive opening of the pressure regulating valve, which otherwise might be caused by the pump pulsation, without leading to the increase in the size of the apparatus.

### Solution to Problem

The brake control apparatus alternately supplies power corresponding to a predetermined current value for acquiring a target wheel cylinder hydraulic pressure, and power corresponding to a larger current value than this predetermined current value to a solenoid of the pressure regulating valve.

### Advantageous Effects of Invention

This brake control apparatus can prevent or reduce the excessive opening of the pressure regulating valve, which otherwise might be caused by the pump pulsation, without leading to the increase in the size of the apparatus.

### BRIEF DESCRIPTION OF DRAWINGS

FIG. 1 illustrates a configuration of a circuit of a brake control apparatus according to a first embodiment.

FIG. 2 schematically illustrates a configuration of a gate-out valve 3 according to the first embodiment.

FIG. 3 is an enlarged view of a main portion of the gate-out valve 3 according to the first embodiment.

FIG. 4 is a flowchart illustrating a flow of processing for performing gate-out valve balance control according to the first embodiment.

FIG. 5 illustrates a relationship between a valve lift amount and an attraction force.

FIG. 6 is a timing diagram illustrating changes in an amount by which a pump discharge brake fluid, a wheel cylinder hydraulic pressure, a stroke of the gate-out valve, the attraction force of a solenoid, and a current of the solenoid when processing for adding an additional current to a target current according to the first embodiment is not performed.

FIG. 7 is a timing diagram illustrating an operation of the processing for adding the additional current to the target current according to the first embodiment.

FIG. 8 is a timing diagram illustrating changes in the amount by which the pump discharge the brake fluid, the wheel cylinder hydraulic pressure, the stroke of the gate-out valve, the attraction force of the solenoid, and the current of the solenoid when the processing for adding the additional current to the target current according to the first embodiment is performed.

### DESCRIPTION OF EMBODIMENTS

### First Embodiment

[Circuit Configuration]

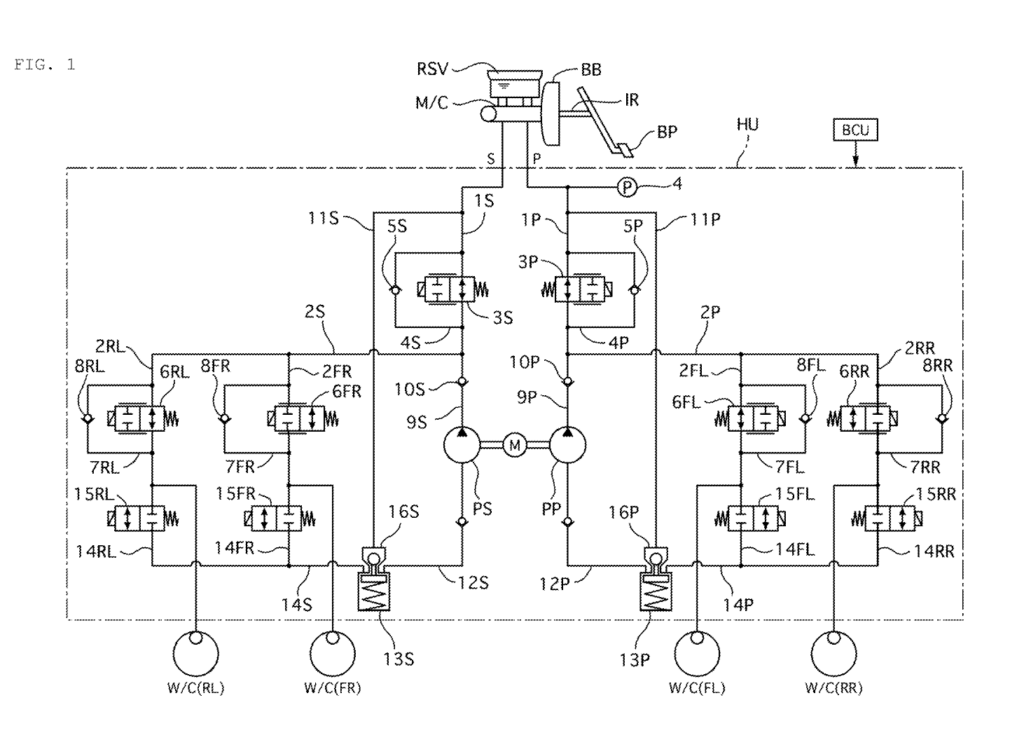

FIG. 1 illustrates a configuration of a circuit of a brake control apparatus according to a first embodiment.

A hydraulic control unit HU serves to adjust a braking force to be applied to each wheel of a vehicle, and increase/reduces or maintains each of hydraulic pressures in a wheel cylinder W/C (RL) at a rear left wheel, a wheel cylinder W/C (FR) at a front right wheel, a wheel cylinder W/C (FL) at a front left wheel, and a wheel cylinder W/C (RR) at a rear right wheel based on an instruction from a brake control unit (a control unit) BCU.

The hydraulic control unit HU has a piping structure called an X-type dual circuit, which includes two systems, a P system and an S system. The employment of the X-type dual circuit allows the hydraulic control unit HU to, even when one pipe system is out of order, generate a half of the braking force under a normal situation with use of another pipe system. An alphabet or alphabets added at the end of the reference numeral of each component illustrated in FIG. 1 has or have the following meaning. “P” indicates that this component belongs to the P system, “S” indicates that this component belongs to the S system. “RL”, “FR”, “FL”, and “RR” indicate that this component corresponds to the rear left wheel, the front right wheel, the front left wheel, and the rear right wheel, respectively. In the following description, the alphabet “P” and “S”, or the alphabets “RL”, “FR”, “FL”, and “RR” will be omitted if the component is described without being specified as to whether this component belongs to the P system or the S system, or which wheel this component corresponds to.

The hydraulic control unit HU according to the first embodiment uses a closed hydraulic circuit. As will be used herein, the term “closed hydraulic circuit” refers to a hydraulic circuit that returns brake fluid supplied to the wheel cylinder W/C to a reservoir tank RSV via a master cylinder M/C. While the term “closed hydraulic circuit” is used to refer to the hydraulic circuit that returns the brake fluid via the master cylinder M/C, the term “open hydraulic circuit” is used to refer to a hydraulic circuit capable of returning the brake fluid supplied to the wheel cylinder W/C directly to the reservoir tank RSV without returning the brake fluid via the master cylinder M/C.

A brake pedal (a brake operation member) BP is connected to the master cylinder M/C via an input rod IR. A pedal pressing force input to the brake pedal BP is boosted by a brake booster (a boosting apparatus) BB. The master cylinder M/C generates a brake hydraulic pressure according to an output of the brake booster BB.

The wheel cylinder W/C (RL) at the rear left wheel RL and the wheel cylinder W/C (FR) at the front right wheel RF are connected to the S system, and the wheel cylinder W/C (FL) at the front left wheel FL and the wheel cylinder W/C (RR) at the rear right wheel RR are connected to the P system. Further, pumps PP and PS are provided to the P system and the S system, respectively. The pumps PP and PS are driven by a single motor M. In the first embodiment, a plunger pump is used as each of the pumps PP and PS.

The master cylinder M/C and the wheel cylinder W/C are connected to each other via pipelines or conduits 1 and 2. A pipeline 2S branches off in a pipeline 2RL and a pipeline 2FR. The pipeline 2RL is connected to the wheel cylinder W/C (RL), and the pipeline 2FR is connected to the wheel cylinder W/C (FR). A pipeline 2P branches off in a pipeline 2FL and a pipeline 2RR. The pipeline 2FL is connected to the wheel cylinder W/C (FL), and the pipeline 2RR is connected to the wheel cylinder W/C (RR).

A gate-out valve (a pressure regulating valve) 3, which is a normally-opened proportional control valve, is provided in the pipeline 1. A master cylinder hydraulic sensor (a brake operation state detector) 4 is provided at a position on a master cylinder side with respect to the gate-out valve 3P in a pipeline 1P in the P system. A pipeline 4 is disposed in the pipeline 1 in parallel with the gate-out valve 3. A check valve 5 is provided in the pipeline 4. The check valve 5 permits the brake fluid to flow from the master cylinder M/C toward the wheel cylinder W/C while prohibiting the brake fluid from flowing in a reverse direction.

A solenoid-in valve 6, which is a normally-opened proportional control valve corresponding to each wheel cylinder W/C, is provided in the pipeline 2. A pipeline 7 is disposed in the pipeline 2 in parallel with the solenoid-in valve 6. A check valve 8 is provided in the pipeline 7. The check valve 8 permits the brake fluid to flow from the wheel cylinder W/C toward the master cylinder M/C while prohibiting the brake fluid from flowing in a reverse direction.

A discharge side of the pump P and the pipeline 2 are connected to each other via a pipeline 9. A discharge valve 10 is provided in the pipeline 9. The discharge valve 10 permits the brake fluid to flow in a direction from the pump P toward the pipeline 2 while prohibiting the brake fluid from flowing in a reverse direction.

A position on the master cylinder side with respect to the gate-out valve 3 in the pipeline 1, and a suction side of the pump P are connected to each other via a pipeline 11 and a pipeline 12. A pressure regulating reservoir 13 is provide between the pipeline 11 and the pipeline 12.

A position on a wheel cylinder side with respect to the solenoid-in valve 6 in the pipeline 2, and the pressure regulating reservoir 13 are connected to each other via a pipeline 14. A pipeline 14S branches off in pipelines 14RL and 14FR, and a pipeline 14P branches off in pipelines 14FL and 14RR. The pipeline 14S and the pipeline 14P are connected to the corresponding wheel cylinder W/C.

A solenoid-in valve 15, which is a normally-closed electromagnetic valve, is provided in the pipeline 14.

The pressure regulating reservoir 13 includes a pressure-sensitive check valve (a one-way valve) 16. When a pressure in the pipeline 11 reaches a high pressure over a predetermined pressure, the check valve 16 prohibits the brake fluid from flowing into the reservoir, thereby preventing a high pressure from being applied to the suction side of the pump P. When the pump P is actuated to lower the pressure in the pipeline 12, the check valve 16 is opened regardless of the pressure in the pipeline 11, thereby permitting the brake fluid to flow into the reservoir.

[Gate-Out Valve]

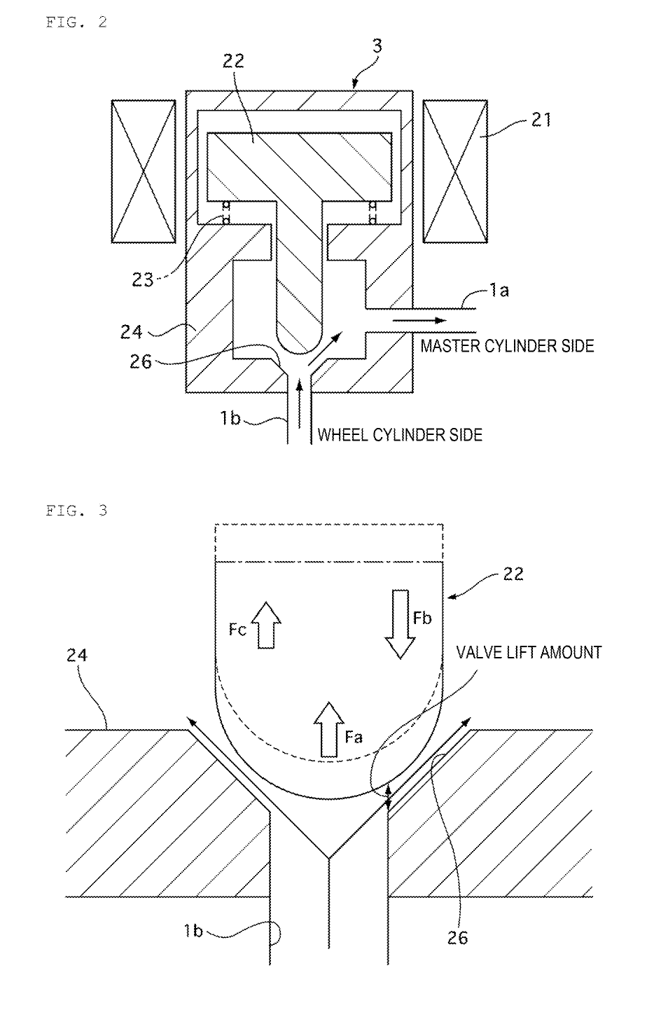

FIG. 2 schematically illustrates a configuration of the gate-out valve 3 according to the first embodiment.

The gate-out valve 3 includes a solenoid 21 that generates an electromagnetic attraction force, a valve member 22 that is actuated according to this electromagnetic attraction force, a coil spring 23 that biases the valve member 22 in a valve opening direction (upward in FIG. 2), and a valve body 24 to which a pipeline 1a on the master cylinder side and a pipeline 1b on the wheel cylinder side with respect to the gate-out valve 3 in the pipeline 1 are connected. When the valve member 22 is displaced downward in FIG. 2, a distal end of the valve member 22 is seated on a seat 26 formed on the valve body 24, which brings the pipeline 1a and the pipeline 1b into a valve closed state. On the other hand, when the valve member 22 is displaced upward in FIG. 2, the distal end of the valve member 22 is separated from the seat 26, which brings the pipeline 1a and the pipeline 1b into a valve opened state. In other words, a communication state (a differential pressure) between the pipeline 1a and the pipeline 1b is determined according to a vertical position of the valve member 22 (a valve lift amount).

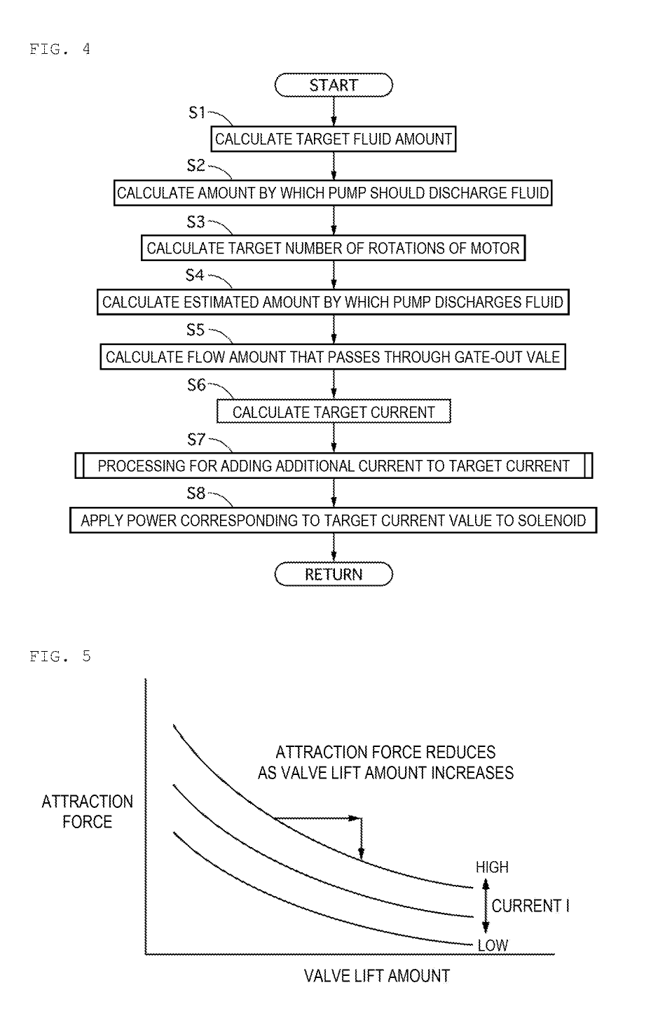

FIG. 3 is an enlarge view of a main portion of the gate-out valve 3 according to the first embodiment.

Forces applied to the valve member 22 include a force Fa according to a differential pressure between a pressure on an upstream side of the gate-out valve 3 (corresponding to a master cylinder hydraulic pressure) and a pressure on a downstream side of the gate-out valve 3 (corresponding to a wheel cylinder hydraulic pressure), which is directed to an upper side in FIG. 3, a force Fb according to the electromagnetic attraction force of the solenoid 21, which is directed to a lower side in FIG. 3, and a force Fc by a biasing force of the coil spring 23, which is directed to the upper side in FIG. 3. The above-described differential pressure can be controlled to a desired value by control of a current to be applied to the solenoid 21. In other words, the biasing force of the coil spring 23 is uniquely determined according to the position of the valve member 22. Therefore, controlling a current value to a predetermined value causes the valve member 22 to perform a stroke to thereby adjust a flow amount flowing through the gate-out valve 3, until the valve member 22 starts to be subject to such a force based on the above-described differential pressure that a balance is eventually established between the electromagnetic attraction force according to this current value and the biasing force of the coil spring 23. As a result, a target differential pressure is achieved. In the following description, this control will be referred to as balance control of the gate-out valve 3. For example, when the solenoid-in valve 6 is opened and the solenoid-out valve 15 is closed, an amount by which the wheel cylinder hydraulic pressure is increased by the pump P is determined according to a difference between an amount by which the fluid is discharged from the pump P, and an amount by which the fluid is leaked from the gate-out valve 3 to the master cylinder M/C. When the master cylinder hydraulic pressure is zero, the differential pressure between the upstream side and the downstream side of the gate-out valve 3 corresponds to the wheel cylinder hydraulic pressure. Therefore, it is possible to automatically adjust an opening degree (the above-described amount by which the fluid is leaked) of the gate-out valve 3 to thereby arbitrarily adjust the wheel cylinder hydraulic pressure, by controlling the number of rotations of the motor M (the amount by which the fluid is discharged from the pump), and also applying power to the solenoid 21 of the gate-out valve 3 to control the electromagnetic force thereof so that the above-described differential pressure matches a desired value.

[Gate-Out Valve Balance Control]

The brake control unit BCU generates a target hydraulic pressure of the wheel cylinder W/C based on signals from the master cylinder hydraulic sensor 4 and another in-vehicle sensor (for example, a wheel speed sensor and/or a steering angle sensor), and drives each actuator of the hydraulic control unit HU so that the wheel cylinder hydraulic pressure matches the target hydraulic pressure. At this time, the above-described balance control is performed with respect to the gate-out valve 3. In particular, in the first embodiment, the balance control includes execution of processing for adding an additional current to a target current, which is processing of periodically adding a predetermined additional current value to the target current value (a predetermined current value) of the solenoid 21 to thereby correct the target current value, for the purpose of preventing or reducing excessive opening of the gate-out valve 3, which otherwise might be caused by a change in the differential pressure due to pump pulsation.

FIG. 4 is a flowchart illustrating a flow of processing for performing the gate-out valve balance control according to the first embodiment. In the following description, each step will be described.

In step Sl, the brake control unit BCU calculates a target fluid amount based on the target hydraulic pressure of the wheel cylinder W/C.

In step S2, the brake control unit BCU calculates an amount by which the pump should discharge the fluid to satisfy the target flow amount calculated in step S1.

In step S3, the brake control unit BCU calculates a target number of rotations of the motor to acquire the amount by which the pump should discharge the fluid, which has been calculated in step S2. At this time, the brake control unit BCU may add a predetermined discharge amount Q_{α} to the amount of the fluid by which the pump should discharge the fluid to calculate the target number of rotations of the motor for achieving the amount by which the pump should discharge the fluid plus the predetermined discharge amount Q_{α}, for the purpose of preventing a delay in a response from the pump P and improving controllability of the gate-out valve 3.

In step S4, the brake control unit BCU calculates an estimated number of rotations of the motor, and then calculates an estimated amount by which the pump discharges the fluid from the estimated number of rotations of the motor.

In step S5, the brake control unit BCU subtracts the target fluid amount calculated in step S1 from the estimated amount by which the pump discharges the fluid, which has been calculated in step S4, to calculate a flow amount that passes through the gate-out valve 3 (the fluid amount leaked to the master cylinder M/C).

In step S6, the brake control unit BCU calculates the target value of the current to be applied to the gate-out valve 3 from the flow amount that passes through the gate-out valve 3, which has been calculated in step S5, and the differential pressure (between the target hydraulic pressure and a sensor value of the master cylinder hydraulic sensor 4).

In step S7, the brake control unit BCU performs the processing for adding the additional current to the target current, which is the processing of periodically (intermittently) adding the predetermined additional current value to the target current value calculated in step S6 to thereby correct the target current value. The additional current value added at this time is assumed to be a value that allows the solenoid 21 to provide the attraction force capable of ensuring a return of the position of the valve member 22 to a control position (a target position) even when a stroke amount of the gate-out valve 3 changes due to the pump pulsation. Further, a cycle of adding the additional current value is assumed to be a discharge cycle of the pump P, i.e. a cycle according to a rotation cycle of the motor M (for example, at the time of a peak of the amount by which the pump discharges the fluid).

In step S8, the brake control unit BCU applies the target current value to the solenoid 21.

Next, a function will be described.

[Function of Preventing or Reducing Drop in Wheel Cylinder Hydraulic Pressure]

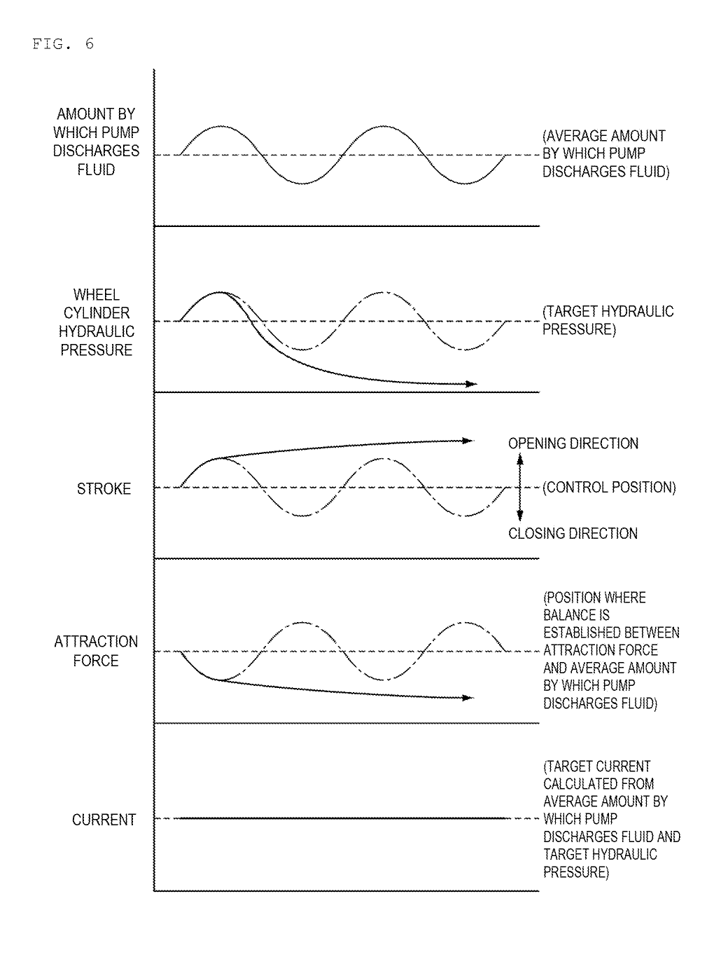

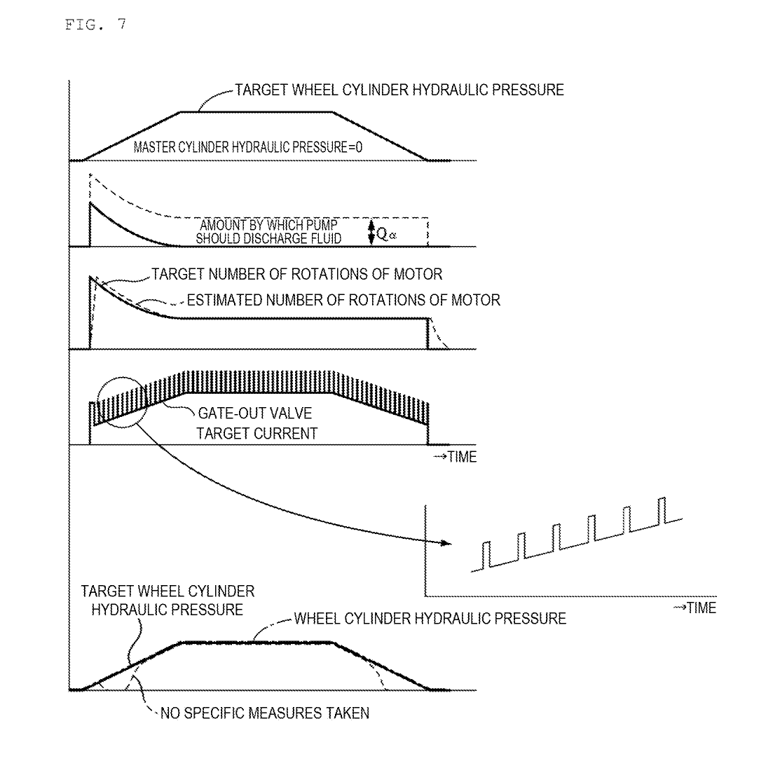

If the target hydraulic pressure of the wheel cylinder and the number of rotations of the pump are constant, the target current to be applied to the solenoid of the gate-out valve is also kept constant according to the target hydraulic pressure and an average of the amount by which the pump discharges the fluid. However, actually, the pulsation is generated with respect to the amount by which the pump discharges the fluid as described above, so that the pressure of the gate-out valve changes on the wheel cylinder side according thereto. At this time, the pressure Fa according to the differential pressure illustrated in FIG. 3 changes at the gate-out valve, which includes the valve member disposed so as to be driven in the valve opening direction by the pressure of the fluid discharged from the pump, like the first embodiment, whereby keeping the current constant leads to a displacement of the valve member from the balance of the gate-out valve to thereby result in a change in the stroke amount. Keeping the current constant causes a change in the attraction force according to the change in the stroke, and may fail to return the stroke to the control position depending on a range of this change in the attraction force. As illustrated in FIG. 5, the attraction force reduces as the valve lift amount increases, and a significant drop of the attraction force may make just continuously applying the constant current insufficient to return the stroke to the control position. At this time, as illustrated in FIG. 6, the attraction force cannot be increased back, and the brake fluid on the wheel cylinder side flows from the gate-out valve to the master cylinder side according to an increase in the stroke, resulting in the wheel cylinder hydraulic pressure falling below the target hydraulic pressure.

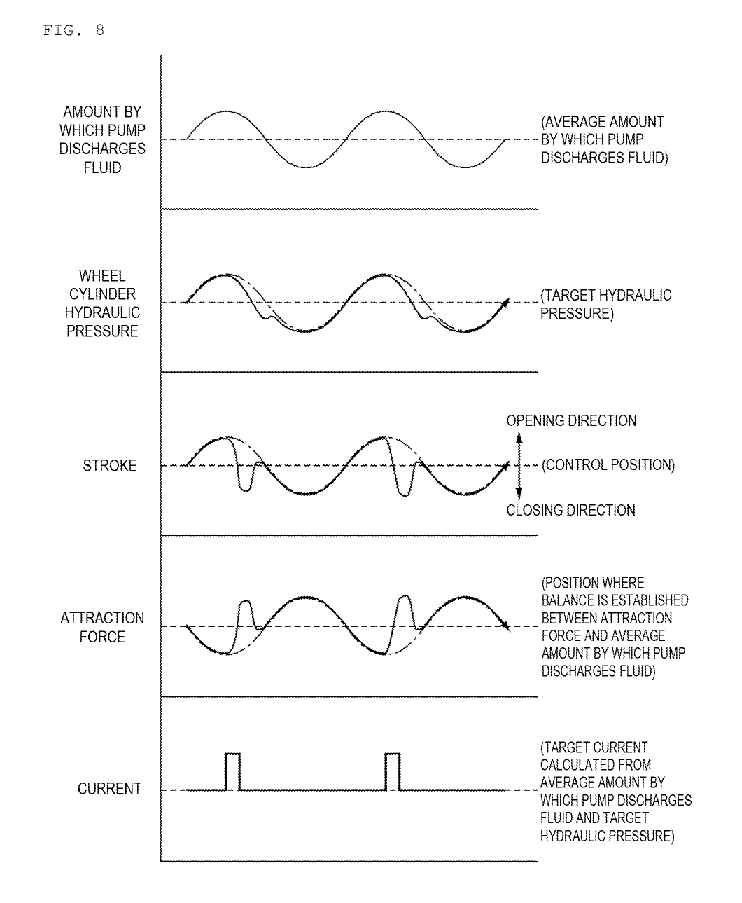

On the other hand, the first embodiment performs the processing for adding the additional current to the target current, which is the processing of periodically adding the predetermined additional current value to the target current value of the gate-out valve 3, as illustrated in a timing diagram illustrated in FIG. 7. In other words, the first embodiment periodically increases the attraction force to forcibly return the valve member 22 to the position to which the valve member 22 is desired to be controlled. As a result, as illustrated in FIG. 8, the first embodiment can forcibly return the stroke of the valve member 22 to the position to which the stroke is desired to be controlled, thereby preventing the gate-out valve 3 from being maintained in the excessively opened state, which otherwise might be caused by the pump pulsation, to prevent the wheel cylinder hydraulic pressure from falling below the target hydraulic pressure.

Further, the processing for adding the additional current to the target current according to the first embodiment is also effective when the target current of the gate-out valve 3 changes. A broken line illustrated in FIG. 7 represents the wheel cylinder hydraulic pressure when the processing for adding the additional current to the target current according to the first embodiment is not performed. When the target hydraulic pressure of the wheel cylinder increases or reduces, the above-described problem is raised if the target current value of the solenoid is small. On the other hand, the first embodiment can prevent the stroke from deviating from the control position by the processing for adding the additional current to the target current, thereby allowing the wheel cylinder hydraulic pressure to follow the target hydraulic pressure.

In the first embodiment, the plunger pump is used as the pump P. The plunger pump is configured to intermittently convey the fluid with use of a reciprocating movement of the plunger, and therefore produces larger pulsation compared to a gear pump or the like. Therefore, this configuration can significantly benefit from the employment of the processing for adding the additional current to the target current according to the first embodiment.

Next, advantageous effects will be described.

The first embodiment can bring about advantageous effects that will be listed below.
(1) The brake control apparatus includes the master cylinder hydraulic sensor 4 configured to detect the operation state of the brake pedal BP operated by the driver, the first hydraulic circuit (the pipeline 1 and the pipeline 2) connecting the master cylinder M/C configured to generate the hydraulic pressure according to the operation performed on the brake pedal BP to the wheel cylinder W/C mounted on each wheel, the pump P configured to be driven according to the result of the detection by the master cylinder hydraulic sensor 4 and configured to, when being driven, discharge the brake fluid sucked via the check valve 16, which limits the transmission of the brake fluid from the master cylinder M/C to the pressure adjusting reservoir 13 and the flow of the brake fluid into the pressure adjusting reservoir 13, and cause the first hydraulic circuit to generate the hydraulic pressure so as to be able to generate the wheel cylinder hydraulic pressure by the discharged brake fluid, the valve member 22 capable of adjusting the differential pressure between the upstream side connected to the wheel cylinder side of the first hydraulic circuit and the downstream side connected to the master cylinder side of the first hydraulic circuit and disposed so as to be driven in the valve opening direction by the pressure of the brake fluid discharged from the pump P, the gate-out valve 3 including the solenoid 21 configured to drive the valve member 22 in the valve closing direction so as to adjust the differential pressure when the power corresponding to the target current value is supplied thereto, and the brake control unit BCU configured to control the amount of the power to be supplied to the solenoid 21. The brake control unit BCU alternately supplies the power corresponding to the target current value and the power corresponding to the larger current value than the target current value (the target current value+the additional current value).

This configuration can prevent or reduce the excessive opening of the gate-out valve 3, which otherwise might be caused by the pump pulsation, thereby preventing the wheel cylinder hydraulic pressure from falling below the target hydraulic pressure.
(2) The pump P is the plunger pump.

This configuration can prevent or reduce the excessive opening of the gate-out valve 3, which otherwise might be caused by the pump pulsation, while employing the plunger pump that tends to produce large pump pulsation.
(3) The cycle of supplying the power corresponding to the larger current value than the target current value is the cycle according to the discharge cycle of the pump P.

This configuration supplies the power corresponding to the high current value according to the cycle in which the pump produces the pump pulsation, and therefore can prevent or reduce the excessive opening of the gate-out valve 3, which otherwise might be caused by the pump pulsation.
(4) The larger current value than the target current value is the target current value with the additional current value added thereto, and the additional current value is a value that allows the solenoid to provide the attraction force enough to return the position of the valve member 22 to the target position even when the stroke amount of the solenoid 21 changes due to the pump pulsation.

This configuration can prevent or reduce the excessive opening of the gate-out valve 3.
(5) The brake control apparatus includes the master cylinder hydraulic sensor 4 configured to detect the operation state of the brake pedal BP operated by the driver, the first hydraulic circuit (the pipeline 1 and the pipeline 2) connecting the master cylinder M/C configured to generate the hydraulic pressure according to the operation performed on the brake pedal 4 to the wheel cylinder W/C mounted on each wheel, the pump P configured to be driven according to the result of the detection by the master cylinder hydraulic sensor 4, and when being driven, discharge the brake fluid sucked via the check valve 16, which limits the transmission of the brake fluid from the master cylinder M/C to the pressure adjusting reservoir 13 and the flow of the brake fluid into the pressure adjusting reservoir 13, and cause the first hydraulic circuit to generate the hydraulic pressure so as to be able to generate the wheel cylinder hydraulic pressure by the discharged brake fluid, the valve member 22 capable of adjusting the differential pressure between the upstream side connected to the wheel cylinder side of the first hydraulic circuit and the downstream side connected to the master cylinder side of the first hydraulic circuit and disposed so as to be driven in the valve opening direction by the pressure of the brake fluid discharged from the pump P, the gate-out valve 3 including the solenoid 21 configured to drive the valve member 22 in the valve closing direction so as to adjust the differential pressure when the power corresponding to the target current value is supplied thereto, and the brake control unit BCU configured to intermittently supply the power corresponding to the target current value and the power corresponding to the larger current value than the target current value as the amount of the power to be supplied to the solenoid 21 when the pump is driven.

This configuration can prevent or reduce the excessive opening of the gate-out valve 3, which otherwise might be caused by the pump pulsation, thereby preventing the wheel cylinder hydraulic pressure from falling below the target hydraulic pressure.

### Other Embodiments

Having described a possible mode for carrying out the present invention based on an exemplary embodiment, the specific configuration of the present invention is not limited to the configuration described in the embodiment, and even a design change and the like are included in the present invention as long as this change and the like are made within the range that does not deviate from the gist of the present invention.

For example, the above-described embodiment has been described based on the example using the plunger pump. However, the pump pulsation is produced even if the gear pump or the like is used, whereby the employment of the present invention can bring about similar advantageous effects to the above-described embodiment.

The brake control apparatus may be configured to additionally include a wheel cylinder hydraulic sensor configured to detect the wheel cylinder hydraulic pressure, and determine the cycle of adding the additional current value to the target current value based on a sensor value of the wheel cylinder hydraulic sensor.

Embodiments of the present invention may also be configured in the following manner.
(1) A brake control apparatus may include a first hydraulic circuit connecting a master cylinder to a wheel cylinder mounted on each wheel, a pump configured to be driven according to a result of detection by the brake operation state detector and configured to, when being driven, discharge brake fluid sucked via a check valve, which limits transmission of the brake fluid from the master cylinder to a reservoir and a flow of the brake fluid into the reservoir, and to cause the first hydraulic circuit to generate a hydraulic pressure so as to be able to generate a hydraulic pressure in the wheel cylinder by the discharged brake fluid, a pressure regulating valve capable of adjusting a differential pressure between an upstream side connected to a wheel cylinder side of the first hydraulic circuit and a downstream side connected to a master cylinder side of the first hydraulic circuit and including a valve member disposed so as to be driven in a valve opening direction by a hydraulic pressure of the brake fluid discharged from the pump and a solenoid configured to drive the valve member in a valve closing direction so as to adjust the differential pressure when power corresponding to a predetermined current value is supplied thereto, and a control unit configured to control an amount of power to be supplied to the solenoid. The control unit may be configured to alternately supply the power corresponding to the predetermined current value and power corresponding to a larger current value than the predetermined current value.
(2) In the brake control apparatus described in the above item (1), the pump may be a plunger pump.
(3) In the brake control apparatus described in the above item (2), the control unit may be configured to alternately supply the power corresponding to the predetermined current value and the power corresponding to the larger current value than the predetermined current value while the pump is driven.
(4) In the brake control apparatus described in the above item (3), a cycle of supplying the power corresponding to the larger current value than the predetermined current value may be a cycle according to a discharge cycle of the pump.
(5) In the brake control apparatus described in the above item (2), the larger current value than the predetermined current value may be the predetermined current value with an additional current value added thereto, and the additional current value may be a value that allows the solenoid to provide an attraction force enough to return a position of the valve member to a target position even when a stroke amount of the solenoid changes due to pulsation of the pump.
(6) The brake control apparatus described in the above item (2) may further include a wheel cylinder hydraulic sensor configured to detect the hydraulic pressure in the wheel cylinder. The control unit may determine a cycle of supplying the power corresponding to the larger current value than the predetermined current value based on the detected hydraulic pressure in the wheel cylinder.
(7) The brake control apparatus described in the above item (1) may further include a brake operation state detector configured to detect an operation state of the brake operation member. The pump may be configured to be driven according to a result of the detection by the brake operation state detector.
(8) A brake control apparatus may include a brake operation state detector configured to detect an operation state of a brake operation member operated by a driver, a first hydraulic circuit connecting a master cylinder configured to generate a hydraulic pressure according to an operation performed on the brake operation member to a wheel cylinder mounted on each wheel, a pump configured to be driven according to a result of the detection by the brake operation state detector and configured to, when being driven, discharge brake fluid sucked via a check valve, which limits transmission of the brake fluid from the master cylinder to a reservoir and a flow of the brake fluid into the reservoir, and to cause the first hydraulic circuit to generate a hydraulic pressure so as to be able to generate a hydraulic pressure in the wheel cylinder by this discharged brake fluid, a pressure regulating valve capable of adjusting a differential pressure between an upstream side connected to a wheel cylinder side of the first hydraulic circuit and a downstream side connected to a master cylinder side of the first hydraulic circuit and including a valve member disposed so as to be driven in a valve opening direction by a hydraulic pressure of the brake fluid discharged from the pump and a solenoid configured to drive the valve member in a valve closing direction so as to adjust the differential pressure when power corresponding to a predetermined current value is supplied thereto, and a control unit configured to intermittently supply power corresponding to the predetermined current value and power corresponding to a larger current value than the predetermined current value as an amount of power supplied to the solenoid when the pump is driven.
(9) In the brake control apparatus described in the above item the pump may be a plunger pump.
(10) In the brake control apparatus described in the above item (9), the control unit may be configured to intermittently supply the power corresponding to the predetermined current value and the power corresponding to the larger current value than the predetermined current value while the pump is driven.
(11) In the brake control apparatus described in the above item (9), a cycle of intermittently supplying the power corresponding to the larger current value than the predetermined current value may be a cycle according to a discharge cycle of the pump.
(12) In the brake control apparatus described in the above item (9), the larger current value than the predetermined current value may be the predetermined current value with an additional current value added thereto, and the additional current value may be a value that allows the solenoid to provide an attraction force enough to return a position of the valve member to a target position even when a stroke amount of the solenoid changes due to pulsation of the pump.
(13) The brake control apparatus described in the above item (9) may further include a wheel cylinder hydraulic sensor configured to detect the hydraulic pressure in the wheel cylinder. The control unit may be configured to determine a cycle of supplying the power corresponding to the larger current value than the predetermined current value based on the detected hydraulic pressure in the wheel cylinder.
(14) A brake control apparatus may include a brake operation member configured to be operated by a driver, a first hydraulic circuit connecting a master cylinder configured to generate a hydraulic pressure according to an operation performed on the brake operation member to a wheel cylinder mounted on each wheel, a plunger pump configured to, when being driven, discharge brake fluid sucked via a check valve, which limits transmission of the brake fluid from the master cylinder to a reservoir and a flow of the brake fluid into the reservoir, and to cause the first hydraulic circuit to generate a hydraulic pressure so as to be able to generate a hydraulic pressure in the wheel cylinder by the discharged brake fluid, and a pressure regulating valve capable of adjusting a differential pressure between an upstream side connected to a wheel cylinder side of the first hydraulic circuit and a downstream side connected to a master cylinder side of the first hydraulic circuit and including a valve member disposed so as to be driven in a valve opening direction by a hydraulic pressure of the brake fluid discharged from the plunger pump and a solenoid configured to drive the valve member in a valve closing direction so as to adjust the differential pressure when power corresponding to a predetermined current value is supplied thereto. The control unit may be configured to supply power corresponding to a larger current value than the predetermined current value while the plunger pump is driven
(15) In the brake control apparatus described in the above item (14), the control unit may be configured to supply the power corresponding to the predetermined current value and the power corresponding to the larger current value than the predetermined current value while the plunger pump is driven.
(16) In the brake control apparatus described in the above item (15), the control unit may be configured to alternately supply the power corresponding to the predetermined current value and the power corresponding to the larger current value than the predetermined current value.
(17) In the brake control apparatus described in the above item (16), the control unit may be configured to supply the power corresponding to the predetermined current value after supplying the power corresponding to the larger current value than the predetermined current value.
(18) In the brake control apparatus described in the above item (16), a cycle of alternatively supplying the power corresponding to the larger current value than the predetermined current value may be a cycle according to a discharge cycle of the pump.
(19) In the brake control apparatus described in the above item (14), the larger current value than the predetermined current value may be the predetermined current value with an additional current value added thereto, and the additional current value may be a value that allows the solenoid to provide an attraction force enough to return a position of the valve member to a target position even when a stroke amount of the solenoid changes due to pulsation of the pump.

Having described merely several embodiments of the present invention, it is apparent to those skilled in the art that the embodiments described as examples can be changed or improved in various manners without substantially departing from the novel teaching and advantages of the present invention. Therefore, such embodiments changed or improved in various manners are intended to be also contained in the technical scope of the present invention.

This application claims priority under the Paris Convention to Japanese Patent Application No. 2013-194383 filed on Sep. 19, 2013. The entire disclosure of Japanese Patent Application No. 2013-194383 filed on Sep. 19, 2013 including the specification, the claims, the drawings, and the summary is incorporated herein by reference in its entirety.

### REFERENCE SIGNS LIST

1 . . . pipeline (first hydraulic circuit)
2 . . . pipeline (first hydraulic circuit)
3 . . . gate-out valve (pressure regulating valve)
4 . . . master cylinder hydraulic sensor (brake operation state detector)
13 . . . pressure regulating reservoir (reservoir)
16 . . . check valve (one-way valve)
21 . . . solenoid
22 . . . valve member
BCU . . . brake control unit (control unit)
BP . . . brake pedal (brake operation member)
M/C . . . master cylinder
P . . . pump
W/C . . . wheel cylinder

1. A brake control apparatus comprising:
a first hydraulic circuit connecting a master cylinder to a wheel cylinder mounted on each wheel;
a pump configured to be driven according to a result of detection by the brake operation state detector, the pump being configured to, when being driven, discharge brake fluid sucked via a check valve, which limits transmission of the brake fluid from the master cylinder to a reservoir and a flow of the brake fluid into the reservoir, and to cause the first hydraulic circuit to generate a hydraulic pressure so as to be able to generate a hydraulic pressure in the wheel cylinder by the discharged brake fluid; and
a pressure regulating valve capable of adjusting a differential pressure between an upstream side connected to a wheel cylinder side of the first hydraulic circuit and a downstream side connected to a master cylinder side of the first hydraulic circuit, the pressure regulating valve including a valve member disposed so as to be driven in a valve opening direction by a hydraulic pressure of the brake fluid discharged from the pump, and a solenoid configured to drive the valve member in a valve closing direction so as to adjust the differential pressure when power corresponding to a predetermined current value is supplied thereto; and
a control unit configured to control an amount of power to be supplied to the solenoid,
wherein the control unit alternately supplies the power corresponding to the predetermined current value and power corresponding to a larger current value than the predetermined current value.

2. The brake control apparatus according to claim 1, wherein the pump is a plunger pump.

3. The brake control apparatus according to claim 2, wherein the control unit alternately supplies the power corresponding to the predetermined current value and the power corresponding to the larger current value than the predetermined current value while the pump is driven.

4. The brake control apparatus according to claim 3, wherein a cycle of supplying the power corresponding to the larger current value than the predetermined current value is a cycle according to a discharge cycle of the pump.

5. The brake control apparatus according to claim 2, wherein the larger current value than the predetermined current value is the predetermined current value with an additional current value added thereto, and the additional current value is a value that allows the solenoid to provide an attraction force enough to return a position of the valve member to a target position even when a stroke amount of the solenoid changes due to pulsation of the pump.

6. The brake control apparatus according to claim 2, further comprising a wheel cylinder hydraulic sensor configured to detect the hydraulic pressure in the wheel cylinder,
wherein the control unit determines a cycle of supplying the power corresponding to the larger current value than the predetermined current value based on the detected hydraulic pressure in the wheel cylinder.

7. The brake control apparatus according to claim 1, further comprising a brake operation state detector configured to detect an operation state of the brake operation member,
wherein the pump is driven according to a result of the detection by the brake operation state detector.

8. A brake control apparatus comprising:
a brake operation state detector configured to detect an operation state of a brake operation member operated by a driver;
a first hydraulic circuit connecting a master cylinder configured to generate a hydraulic pressure according to an operation performed on the brake operation member to a wheel cylinder mounted on each wheel;
a pump configured to be driven according to a result of the detection by the brake operation state detector, the pump being configured to, when being driven, discharge brake fluid sucked via a check valve, which limits transmission of the brake fluid from the master cylinder to a reservoir and a flow of the brake fluid into the reservoir, and to cause the first hydraulic circuit to generate a hydraulic pressure so as to be able to generate a hydraulic pressure in the wheel cylinder by this discharged brake fluid;
a pressure regulating valve capable of adjusting a differential pressure between an upstream side connected to a wheel cylinder side of the first hydraulic circuit and a downstream side connected to a master cylinder side of the first hydraulic circuit, the pressure regulating valve including a valve member disposed so as to be driven in a valve opening direction by a hydraulic pressure of the brake fluid discharged from the pump, and a solenoid configured to drive the valve member in a valve closing direction so as to adjust the differential pressure when power corresponding to a predetermined current value is supplied thereto; and
a control unit configured to intermittently supply power corresponding to the predetermined current value and power corresponding to a larger current value than the predetermined current value as an amount of power supplied to the solenoid when the pump is driven.

9. The brake control apparatus according to claim 8, wherein the pump is a plunger pump.

10. The brake control apparatus according to claim 9, wherein the control unit intermittently supplies the power corresponding to the predetermined current value and the power corresponding to the larger current value than the predetermined current value while the pump is driven.

11. The brake control apparatus according to claim 9, wherein a cycle of intermittently supplying the power corresponding to the larger current value than the predetermined current value is a cycle according to a discharge cycle of the pump.

12. The brake control apparatus according to claim 9, wherein the larger current value than the predetermined current value is the predetermined current value with an additional current value added thereto, and the additional current value is a value that allows the solenoid to provide an attraction force enough to return a position of the valve member to a target position even when a stroke amount of the solenoid changes due to pulsation of the pump.

13. The brake control apparatus according to claim 9, further comprising a wheel cylinder hydraulic sensor configured to detect the hydraulic pressure in the wheel cylinder,
wherein the control unit determines a cycle of supplying the power corresponding to the larger current value than the predetermined current value based on the detected hydraulic pressure in the wheel cylinder.

14. A brake control apparatus comprising:
a brake operation member configured to be operated by a driver;
a first hydraulic circuit connecting a master cylinder configured to generate a hydraulic pressure according to an operation performed on the brake operation member to a wheel cylinder mounted on each wheel;
a plunger pump configured to, when being driven, discharge brake fluid sucked via a check valve, which limits transmission of the brake fluid from the master cylinder to a reservoir and a flow of the brake fluid into the reservoir, and to cause the first hydraulic circuit to generate a hydraulic pressure so as to be able to generate a hydraulic pressure in the wheel cylinder by the discharged brake fluid; and
a pressure regulating valve capable of adjusting a differential pressure between an upstream side connected to a wheel cylinder side of the first hydraulic circuit and a downstream side connected to a master cylinder side of the first hydraulic circuit, the pressure regulating valve including
a valve member disposed so as to be driven in a valve opening direction by a hydraulic pressure of the brake fluid discharged from the plunger pump, and a solenoid configured to drive the valve member in a valve closing direction so as to adjust the differential pressure when power corresponding to a predetermined current value is supplied thereto,
wherein the control unit supplies power corresponding to a larger current value than the predetermined current value while the plunger pump is driven

15. The brake control apparatus according to claim 14, wherein the control unit supplies the power corresponding to the predetermined current value and the power corresponding to the larger current value than the predetermined current value while the plunger pump is driven.

16. The brake control apparatus according to claim 15, wherein the control unit alternately supplies the power corresponding to the predetermined current value and the power corresponding to the larger current value than the predetermined current value.

17. The brake control apparatus according to claim 16, wherein the control unit supplies the power corresponding to the predetermined current value after supplying the power corresponding to the larger current value than the predetermined current value.

18. The brake control apparatus according to claim 16, wherein a cycle of alternatively supplying the power corresponding to the larger current value than the predetermined current value is a cycle according to a discharge cycle of the pump.

19. The brake control apparatus according to claim 14, wherein the larger current value than the predetermined current value is the predetermined current value with an additional current value added thereto, and the additional current value is a value that allows the solenoid to provide an attraction force enough to return a position of the valve member to a target position even when a stroke amount of the solenoid changes due to pulsation of the pump.

20. A brake control apparatus comprising:
a valve member disposed so as to be driven in a valve opening direction by a hydraulic pressure of brake fluid discharged from a pump;
a solenoid configured to drive the valve member in a valve closing direction when power corresponding to a predetermined current value is supplied thereto; and
a control unit configured to control the solenoid,
wherein the control unit can alternately supply the power corresponding to the predetermined current value and power corresponding to a larger current value than the predetermined current value to the solenoid.
